(19) United States
(12) Patent Application Publication
(10) Pub. No.: US 2023/0086049 A1
(43) Pub. Date: Mar. 23, 2023

(54) SYSTEMS AND METHODS OF PREDICTING THE REMAINING USEFUL LIFE OF INDUSTRIAL MECHANICAL POWER TRANSMISSION EQUIPMENT USING A MACHINE LEARNING MODEL

(71) Applicant: ABB Schweiz AG, Baden (CH)

(72) Inventors: Stefan Rakuff, Raleigh, NC (US); Marius Rutkevicius, Raleigh, NC (US); Rajib Mikail, Raleigh, NC (US)

(21) Appl. No.: 17/480,934

(22) Filed: Sep. 21, 2021

(51) Int. Cl. G05B 23/02; G06N 20/00

(52) U.S. Cl. CPC G05B 23/0283; G05B 23/0248; G06N 20/00

(57) ABSTRACT

A life prediction system for industrial mechanical power transmission equipment is provided. The system includes a life prediction computing device, the life prediction computing device including at least one processor in communication with at least one memory device, and the at least one processor programmed to receive data of a gearbox measured by one or more sensors, predict remaining useful lifetime of the gearbox based on the received data by using a machine learning model, and output the predicted life of the gearbox.

### BACKGROUND

The field of the disclosure relates to predicting the remaining useful life of a gearbox, and more particularly, to predicting the life of a gearbox using a machine learning model.

A gearbox, e.g., a gear reducer, is a mechanical device that reduces the rotational speed and increases the torque generated by an input power source. In some instances, a gearbox may be part of a mechanical power transmission system. For example, the gearbox changes the speed and torque of the prime mover, e.g., a motor, and is located between the prime mover and a piece of driven machinery. A gearbox may achieve its intended effect by having an input gear drive an output gear that has more teeth than the input gear, causing the output gear to rotate more slowly. The gearbox may be operatively coupled to and/or include a gearbox sensor system. The sensor system may include one or more sensors that are capable of obtaining sensor information, such as gearbox usage parameters of speed, torque, overhung (radial and axial) forces applied to the input and output shafts. A pillow block bearing is a mechanical device designed to support a rotating shaft. Typical bearings have a cast iron, cast steel, or polymer housing with balls, rollers, or a journal supporting the shaft. These bearings sometimes may be split. Bearings are designed for radial load, thrust load, or both. Both bearings and gearboxes are industrial mechanical power transmission devices.

Gearboxes may be used for many applications and within many different industries such as food processing, mining, automotive, and agricultural industries. Regardless of the application or industry, unplanned down-time due to gearbox failures may be costly, for example, due to lost production. Catastrophic gearbox failures may occur due to mechanical defects, such as breaking of the gear teeth or bearing failures. While preventive maintenance and inspections may be performed regularly to reduce the probability of unplanned down-time of the gearbox, this incurs undesirable labor costs, requires maintaining spare parts, and necessitates frequent scheduled down-times.

Known systems and methods of monitoring gearbox conditions are disadvantaged in some aspects and improvements are desired.

### BRIEF DESCRIPTION

In one aspect, a life prediction system for power transmission equipment is provided. The system includes a life prediction computing device, the life prediction computing device including at least one processor in communication with at least one memory device. The at least one processor is programmed to receive data of a gearbox measured by one or more sensors, and predict remaining useful lifetime of the gearbox based on the received data by using a machine learning model, wherein the machine learning model incudes a life prediction model. The at least one processor is further programmed to in the life prediction model, for each component of the gearbox and each failure mode, identify a matching component of the component with an existing component in a database, wherein the database includes data of failed gearboxes and failure modes of the failed gearboxes, select a strategy in a rule base of predicting remaining useful lifetime of the component, and predict a life of the component at the failure mode using the strategy based on the matching component. The at least one processor is further programmed to predict a life of the gearbox based on the predicted lives of the components. The at least one processor is also programmed to output the predicted life of the gearbox.

In another aspect, a method of predicting remaining useful lifetime of power transmission equipment is provided. The method includes receiving data of the power transmission equipment measured by one or more sensors, and predicting remaining useful lifetime of the power transmission equipment based on the received data by using a machine learning model, wherein the machine learning model incudes a life prediction model. Predicting remaining useful lifetime of the power transmission equipment further includes in the life prediction model, for each component of the power transmission equipment and each failure mode, identifying a matching component of the component with an existing component in a database, wherein the database includes data of failed power transmission equipment and failure modes of the failed power transmission equipment, selecting a strategy in a rule base of predicting remaining useful lifetime of the component, and predicting a life of the component at the failure mode using the strategy based on the matching component. Predicting remaining useful lifetime of the power transmission equipment further includes predicting a life of the power transmission equipment based on the predicted lives of the components. The method also includes outputting the predicted life of the power transmission equipment.

In one more aspect, a life prediction system for a gearbox is provided. The system includes a life prediction computing device, the life prediction computing device including at least one processor in communication with at least one memory device, and the at least one processor programmed to receive data of the gearbox measured by one or more sensors, predict remaining useful lifetime of the gearbox based on the received data by using a machine learning model, and output the predicted life of the gearbox.

### DRAWINGS

FIG. 1A is a block diagram of an exemplary life prediction system.

FIG. 1B is an exemplary gearbox assembly for the system shown in FIG. 1A.

FIG. 1C is a cross-sectional view of the gearbox taken along line 1C-1C in FIG. 1B.

FIG. 2 is a flow chart of an exemplary method of predicting remaining useful lifetime of a gearbox.

FIG. 3A is a schematic diagram of an exemplary embodiment of the method shown in FIG. 2.

FIG. 3B is a flow chart of the exemplary embodiment shown in FIG. 3A.

FIG. 4A is a schematic diagram of another exemplary embodiment of the method shown in FIG. 2.

FIG. 4B is a flow chart of the exemplary embodiment shown in FIG. 4A.

FIG. 5 is a flow chart of an exemplary process of reinforcement learning in the machine learning model shown in FIG. 1A.

FIG. 6 is a block diagram of an exemplary user computing device.

FIG. 7 is a block diagram of an exemplary server computing device.

### DETAILED DESCRIPTION

The disclosure includes systems and methods of predicting remaining useful lifetime of a gearbox using a machine learning model. As used herein, remaining useful lifetime is the time period in which the gearbox components function as required to be functionally operating for intended applications of the gearbox. Remaining useful lifetime may also be referred to as life, lifetime, life expectancy, or remaining life. A gearbox is used herein as an example for illustration purposes only. Systems and methods described herein may be applied to any industrial mechanical power transmission equipment, such as a motor, bearing, sheave, sprocket, or pulley. Method aspects will be in part apparent and in part explicitly discussed in the following description.

Currently, gearbox condition monitoring is often carried out manually by a field engineer or technician who periodically inspects the gearboxes for unusual behavior. This may include measuring vibrations and listening for any unusual acoustic patterns coming from a gearbox, checking the oil fill level and oil condition, changing the oil, and checking the temperature of the oil, bearings, and other components. Due to the labor costs, it may not be feasible to carry out these inspections regularly. Some users of gearboxes may not carry out any inspections at all and then suddenly experience a catastrophic failure and downtime without any warning. Accordingly, there remains a technical need to determine the lifetime expectancy of the gearbox with manual inspection minimized to ensure fewer unplanned down-times.

A physics model based on empirical relations between operating conditions and mean time to failure may be used to calculate the expected remaining bearing lifetime and the remaining life of shafts and gears before fatigue failure. However, the empirical equations are only applicable to ideal conditions for which the empirical relations were derived. Some examples of ideal conditions may be that oil is particulate free and, therefore, does not cause wear to gearbox components, gearboxes are manufactured within the tolerances, gearboxes are used in ideal environmental conditions (e.g., no dust or humidity ingress), and gearbox operation speed, torque and overhung loading are within the nominal rating.

However, every gearbox is manufactured with tolerances determined by the manufacturing processes. Furthermore, every customer may subject the gearbox to different maintenance schedules, different environments, and different loading conditions. Therefore, a physics model alone does not factor in all the non-ideal parameters such that calculated gearbox lifetime is with reasonable accuracy.

Systems and methods described herein provide a prediction of the remaining useful life of a gearbox using a machine learning model based on real time data of the gearbox, without the requirement of inspection. The machine learning model may be used in conjunction with the physics model. The machine learning model may be fitted or trained with data obtained from failed gearboxes. The data includes component parameters (e.g., gearbox component dimensions and gearbox assembly parameters such as bearing clearances), usage parameters (e.g., oil quality, oil impedance, metal particle count, viscosity, torque, radial loads, temperature, and/or vibration data) of gearboxes at various customer sites, and the achieved useful life of the failed components. In one example, the machine learning model may not be trained before being used to predict remaining useful lifetime of a gearbox. Instead, the machine learning model may be trained while the machine learning model is being used to predict remaining useful lifetime of a gearbox. To reduce demand on training data, systems and methods described herein may use both a physics model and a machine learning model in predicting remaining useful lifetime of a gearbox. In addition, the machine learning may be used to predict future loads of the gearbox, thereby increasing accuracy of the life prediction.

The life of the gearbox may be limited by various failure modes. Example failure modes include spalling of the races of the rolling element bearings, pitting and micro-pitting of the gear flanks, tooth breakage and scuffing of the gear flanks. Additional failures may occur as shaft seal leaks or fatigue failures of shafts, keyways, housings, or breakdown and contamination of lubricants. The systems and methods described herein apply to all types of failures. At the beginning, the machine learning model will start with few selected failure modes with certain accuracy levels. With more data the accuracy levels may increase.

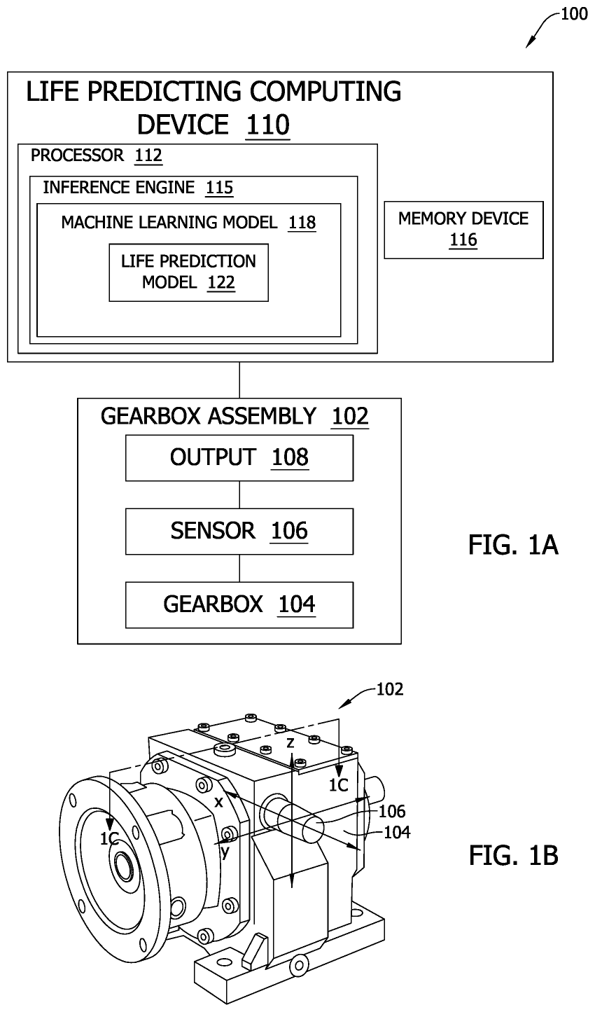

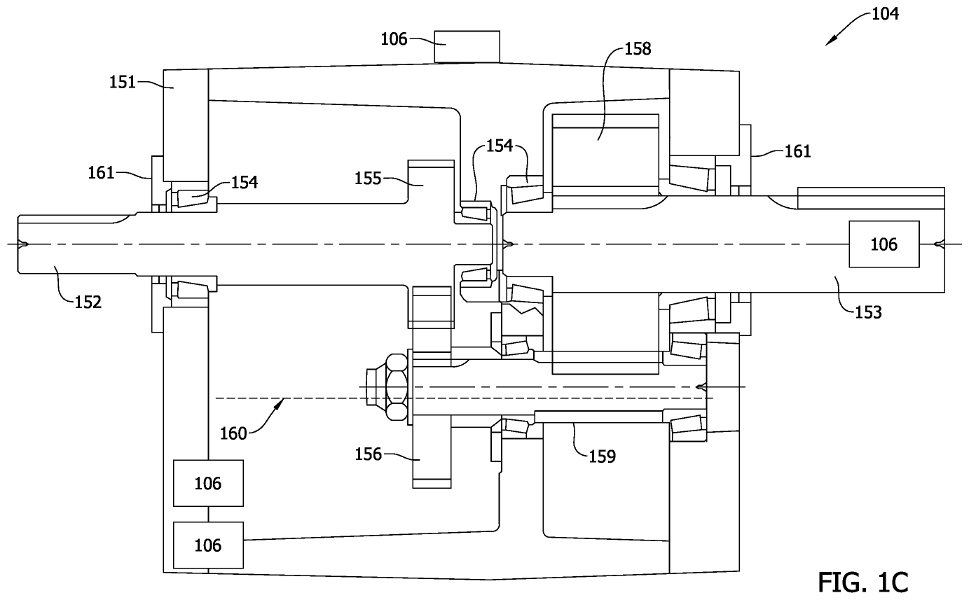

FIGS. 1A-1C show an exemplary life prediction system 100 and an exemplary gearbox assembly 102 in life prediction system 100. FIG. 1A is a block diagram of life prediction system 100. FIG. 1B is a perspective of gearbox assembly 102. FIG. 1C is a cross-sectional view of gearbox assembly 102 along a cross-sectional line 1C-1C as marked in FIG. 1B.

In the exemplary embodiment, system 100 includes gearbox assembly 102. Gearbox assembly 102 includes a gearbox 104. Gearbox assembly 102 may further include one or more sensors 106.

In the exemplary embodiment, gearbox 104 has a housing 151 enclosing the internal components (e.g., shafts, gears, and bearings) of gearbox 104 (FIG. 1C). Gearbox 104 includes an input shaft 152 and an output shaft 153. Shafts 152, 153 are partially protruding out of the housing 151 so that the shafts may be operatively coupled to other devices, e.g., a prime mover and/or the driven equipment. Gearbox 104 may further include an intermediate shaft 159.

Gearbox 104 may be a concentric gear reducer, i.e., with concentric input shaft 152 and output shaft 153. Systems and methods described herein are not limited to a particular design of gearbox, but may be applied to a variety of types and configurations of gearbox and/or machinery. For example, the gearbox may be a right-angle reducer, a parallel-shaft reducer, a Dodge QUANTIS gearbox, a Dodge MAXUM XTR gearbox, a Dodge MAGNAGEAR gearbox, or a Dodge TORQUE ARM gearbox.

In the exemplary embodiment, gearbox 104 includes a plurality of bearings 154. Bearings 154 are between shafts 152, 153, 159 and housing 151, and affix all but one degrees of freedom of shafts 152, 153 within housing 151 and allow the shafts to rotate. Bearings 154 are typically rolling element bearings. There are many different types of rolling element bearings that may be used such as tapered roller bearings, cylindrical roller bearings, and ball bearings.

In the exemplary embodiment, gearbox 104 includes gears 155, 156, 158 affixed to input shaft 152, an intermediate shaft 159, and output shaft 153. Teeth of adjacent gears operationally mesh with each other such that rotation of input shaft 152 results in intermediate shaft 159 and output shaft 153 also rotating. The gears have particular characteristics, such as a pitch circle diameter, a working diameter, and number of teeth. By adjusting the characteristics of the gears, various reductions in speed and increases in torque are achieved. For example, if first gear 155 has fewer teeth than second gear 156, intermediate shaft 159 will have a lower rotational speed as compared to that of input shaft 152.

Housing 151 may also contain oil for lubrication and cooling the kinematic components of gearbox 104. The oil may be filled to a defined oil level 160. Seals 161 are located at the openings for input shaft 152 and output shaft 153 to seal interior of housing 151.

In driving a load, input shaft 152 is operatively coupled to a prime mover, e.g., an electric motor, and output shaft 153 is operatively coupled to driven equipment or load, e.g., the conveyor, feeder, and/or mill. Gearbox 104 may be configured to reduce the rotational speed at input shaft 152 to output a lower speed at output shaft 153 and to increase the torque applied to input shaft 152 to output a higher torque at output shaft 153.

Each of constituent components of gearbox 104 may eventually have mechanical defects, which may result in a failure of gearbox 104, including a minor failure (e.g., a reduction in operating performance) and a catastrophic failure (e.g., a failure which results in the complete loss of function). Such mechanical defects may develop over time (e.g., due to age, wear caused by particulates in the oil, scuffing of contacting gear tooth flanks due to high specific sliding speeds, or fatigue from a high number of cyclic stresses), or may be latent defects originating from the manufacturing process of the component, material imperfections of the components, or the assembling of gearbox 104. Furthermore, minor defects may grow to become more severe over time.

Gearboxes 104 may fail catastrophically if defects within gearbox 104 are not detected in time. A catastrophic gearbox failure implies that the gearbox is no longer able to function, and mechanical power from a prime mover (e.g. an electric motor) may no longer be transmitted to a load (e.g., a conveyor belt or a pump). The catastrophic failure of the gearbox may lead to a dangerous condition where the motion of a load may no longer be controlled. Accordingly, the entire and/or a partial operation of a business unit, such as a manufacturing plant, may stop. For example, gearbox 104 may be on a production line and due to the failure, the production line may encounter an unplanned shut down, which may be costly for the business unit. As such, systems and methods of determining the life of gearboxes are desired so as to reduce unplanned shutdowns.

The life of the gearbox may be limited by various failure modes. That is, the discrete components within the gearbox have discrete lifetime expectancies. Accordingly, as a result of the present embodiment, the lifetime expectancies of the components (e.g., the bearings, gears, seals, shafts, oil, and housing) within the gearbox are predicted.

Two of the main component categories in a gearbox that often show signs of defects are the gears (such as gears 155, 156, 158) and the bearings (such as, bearings 154).

Common categories of gear defects include wear, scuffing, plastic deformation, bending fatigue, contact fatigue, cracking and other damage (see e.g., ANSI/AGMA 1010-F14 describing these categories of gear defects). Examples of failures originating from these defects include, gears developing a tooth root crack that may lead to a fracture of the gear tooth, or plastic deformation of gears that becomes sufficiently large so that gear meshing is negatively affected. Defects of any type may ultimately lead to catastrophic failure of the gearbox. For example, fragments of failing defective components may cause a series of cascading events that result in further damage and ultimately lead to a catastrophic failure.

A similar set of defect categories may be defined for the rolling element bearings as well. Also, similar to the gears, initially minor defects may mature into significant issues. For example, a rolling element bearing may have a small initial defect located on the inner bearing ring. During operation, the small defect may grow over time, cracks may form and propagate to the surface of the inner bearing ring, pieces of metal may separate, and the severely-damaged inner bearing ring and metal debris may cause bearing seizure, and ultimately cause the associated system to fail.

Gears and bearings are not the only source of defects and device failure. For example, fatigue failure due to cyclic loading of the (rotating) shafts (such as shafts 152, 153, and 159) may also be a problem. The fatigue failure may develop as a fracture of the shaft, which may occur in areas of high stress concentrations (such as keyways, splines, or corners). Another example includes misalignment of the motor and input shaft 152 that may lead to defects and eventual failure of the shaft coupling or the bearings due to high radial and axial loads, moment loads, and temperatures. Shaft seal failures and loss of oil may lead to problems from lack of lubrication. Lubrication problems may also occur with excessive heat or oil contamination.

Gearbox 104 defects (and failures) are often accompanied by other kinds of performance characteristics exhibited by the gearbox 104 (such as, excessive vibrations, acoustic emissions, and abnormal temperatures). As such, gearbox sensors (e.g., sensors 106) may detect these exhibited problematic performance characteristics (e.g., abnormal temperatures, vibrations, and/or acoustical emissions), and life prediction computing device 110 is used to predict the life of the gearbox.

In the exemplary embodiment, gearbox assembly 102 includes one or more sensors 106 configured to provide information associated with gearbox 104. Sensor 106 include, but are not limited to, torque sensors, speed sensors, temperature sensors (e.g., thermocouples, RTDs), overhung force sensors, vibration sensors (e.g., piezoelectric accelerometers, laser vibrometers), strain gauges, acoustic sensors (e.g., microphones), oil parameter sensors (e.g. optical sensors, resonant or conductive sensors), proximity sensor, and/or humidity sensors. Sensor 106 may also be a sensor that measures environmental conditions such as ambient temperature, pressure, humidity, and/or altitude. Sensor 106 may be placed on gearbox 104 or inside gearbox 104 (FIG. 1C). Sensor 106 may be placed in the environment of gearbox 104.

System 100 may further include an output 108 that is a communication device. Information developed by sensor 106 such as measurements is communicated to output 108. Output 108 sends the information to other devices through wired communication such as Ethernet, or through wireless communication such as Wi-Fi or through radio waves. Output 108 may be part of sensor 106 or part of gearbox 104. Output 108 may be positioned in sensor 106 or gearbox 104, or separately from gearbox 104 or sensor 106.

The system 100 further includes a life prediction computing device 110. In one example, computing device 110 is a computing device located remotely from gearbox 104. In some embodiments, computing device 110 is located on gearbox 104 or in sensor 106. In other embodiments, computing device 110 is located outside and proximate gearbox 104.

The computing device 110 is configured to process measured data sent from gearbox assembly 102. For example, computing device 110 is configured to process the measured data by sensor 106. In another example, computing device 110 is configured to predict remaining useful lifetime of gearbox 104.

In the exemplary embodiment, computing device 110 includes a processor 112 having an inference engine 115 and a memory device 116. The inference engine 115 is configured to predict remaining useful lifetime of gearbox 104. Inference engine 115 includes a machine learning model 118. Machine learning model 118 is configured to carry out the function of inference engine 115 such as predicting remaining useful lifetime of gearbox 104. Machine learning model 118 may also be configured to estimate future loads of gearbox 104 based on historic loads or information about the process the gearbox is used in for increased accuracy in prediction of lives. Machine learning model 118 may be a convolutional neural network, regressor, or a classifier. ML model may be supervised, unsupervised, or reinforcement. Reinforcement machine learning model 118 may further include life prediction model 122 configured to predict remaining useful lifetime of gearbox 104.

The life prediction computing device 110 may be a server computing device. In some embodiments, life prediction computing device 110 is a user computing device. In one embodiment, life prediction computing device 110 is cloud-based or edge-computing based. The life prediction computing device 110 may communicate with gearbox assembly 102 through wireless communication. Alternatively, computing device 110 may communicate with gearbox assembly 102 through wired communication. Gearbox assembly 102 may upload data stored in memory device of gearbox assembly 102 such as in sensor 106 to computing device 110 periodically. In some embodiments, gearbox assembly 102 uploads the data in real time to computing device 110.

In some embodiments, life prediction computing device 110 includes a processor-based microcontroller including a processor 112 and a memory device 116 wherein executable instructions, commands, and control algorithms, as well as other data and information needed to satisfactorily operate life prediction system 100, are stored. Memory device 116 may be, for example, a random access memory (RAM), and other forms of memory used in conjunction with RAM memory, including but not limited to flash memory (FLASH), programmable read only memory (PROM), and electronically erasable programmable read only memory (EEPROM).

As used herein, the term “processor-based” microcontroller shall refer not only to controller devices including a processor or microprocessor as shown, but also to other equivalent elements such as microcomputers, programmable logic controllers, reduced instruction set circuits (RISC), application specific integrated circuits and other programmable circuits, logic circuits, equivalents thereof, and any other circuit or processor capable of executing the functions described below. The processor-based devices listed above are exemplary only, and are thus not intended to limit in any way the definition and/or meaning of the term “processor-based.”

In operation, parameters of gearbox 104 are measured by sensor 106. The data are transmitted to life prediction computing device 110. Life prediction computing device 110 then predicts remaining useful lifetime of gearbox 104 based on the measured data.

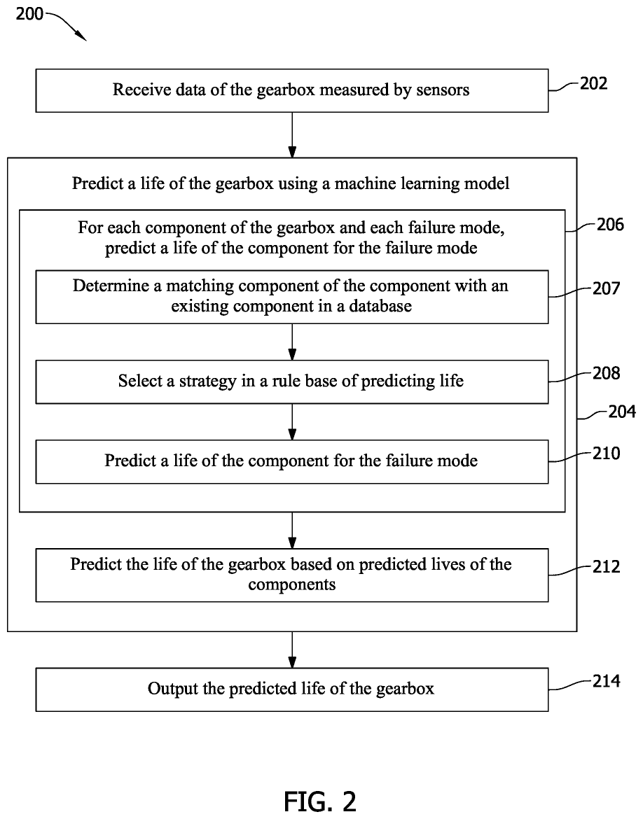

FIG. 2 is a flow chart of an exemplary method of predicting 200 remaining useful lifetime of a gearbox. Method 200 includes receiving 202 data of the gearbox measured by sensors. Method 200 further includes predicting 204 remaining useful lifetime of the gearbox using a machine learning model. Predicting 204 remaining useful lifetime of the gearbox further includes for each component of the gearbox and each failure mode, predicting 206 remaining useful lifetime of the component for the failure mode. In predicting 206 remaining useful lifetime of the component, a matching component of the component with an existing component in a database is determined 207. The database includes data of failed gearboxes such as lifetimes to failure of the failed gearboxes and failure modes of the failed gearboxes. A strategy is selected 208 from a rule base of predicting remaining useful lifetime of the component. The life of the component for the failure mode is predicted 210 using the strategy based on the matching component. Predicting 204 remaining useful lifetime of the gearbox further includes predicting 212 the life of the gearbox based on predicted lives of the components. Predicting 212 the life of the gearbox may be carried out after all components for all failure modes have been evaluated. In some embodiments, predicting 212 the life of the gearbox may be carried out after lives of components in a predetermined list of components and/or for failure modes in a predetermined list of failure modes have been predicted. Method 200 further includes outputting 214 the predicted life of the gearbox. For example, the predicted life of the gearbox may be displayed or sent to field engineers and/or the customer as a reference for maintenance.

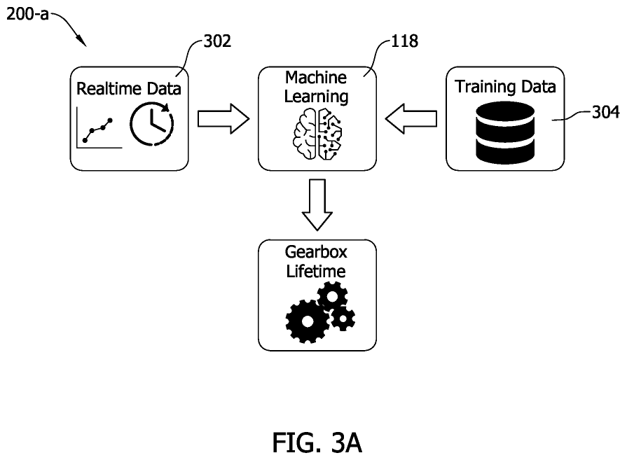

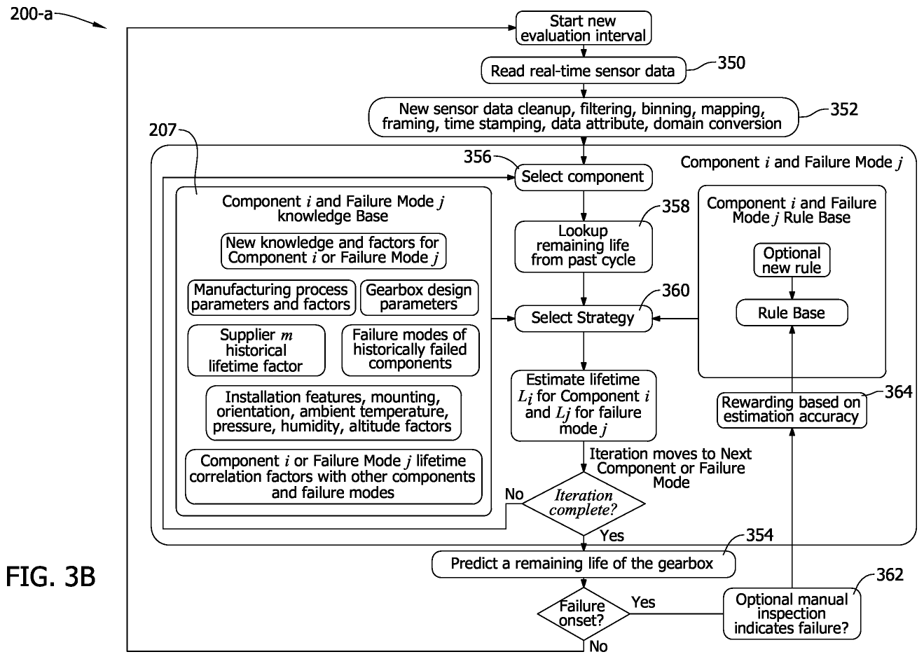

FIGS. 3A and 3B show an exemplary embodiment 200-a of method 200 for predicting life of a gearbox. FIG. 3A is a schematic diagram of method 200-a. FIG. 3B is a flow chart of method 200-a.

In the exemplary embodiment, method 200-a is for gearbox life calculation based on machine learning (ML) approximation using real time data 302 and training data 304 from other gearboxes. Real time data 302 include data measured by sensors 106 (FIG. 1A) and other data related gearbox 104, environment, or suppliers. Training data 304 may include data of failed gearboxes, such as lives and failure modes of the failed gearboxes. Because the gearboxes have failed, the lives of those gearboxes are known. Training data 304 may be stored in a database. In operation, real time data 302 and training data 304 are input into machine learning model 118 in predicting 204 life of a gearbox.

In the exemplary embodiment, method 200-a may be repeated periodically, where the life of the gearbox is predicted at an evaluation interval, such as a day or month. Real time data are fed 350 into the ML model. Real time data 302 include measurement data from sensors for measuring gearbox vibration, speed, temperature (including temperature difference from the ambient environment), torque, overhung shaft forces, and/or oil quality. Real time data 302 may also include other data related to a gearbox, such as manufacturing parameters, gearbox design parameters, supplier historical life data, and installation parameters if predicting 204 is perform for the first time for the gearbox and/or those data have not been stored in machine learning model 118.

In the exemplary embodiment, the real time data may be processed 352 before being input into machine learning model. Alternatively, the real time data may be preprocessed in machine learning model 118. Preprocesses may include scaling, denoising, filtering, binning, mapping, framing, time stamping, and/or deriving or marking data attributes. Preprocesses used depend on the quality of the data and the need on the data input into machine learning model 118. In one embodiment, real time data are Fourier transformed to generate frequency spectra of the data. For example, sensor data may be cyclic and frequency spectra of different components of gearbox have different distinct characteristics, such as input shaft 152 having more peaks at high frequencies than output shaft 153.

In the exemplary embodiment, method 200-a includes predicting 204 remaining useful lifetime of the gearbox. In Predicting 204 remaining useful lifetime of the gearbox, lives of components of the gearbox and lives of failure modes are predicted. The remaining life of the gearbox are then predicted 354 based on the lives of components of the gearbox and lives of failure modes. In some embodiments, the life of gearbox 104 is determined as the life of a particular component that has the lowest life remaining. For example, gears 155, 156, and 158 may have 1,000 hours, 2,000 hours, and 3,000 hours of lifetime expectancy remaining, respectively. The life of the gearbox 104 is determined as 1000 hours, the shortest life among gears 155, 156, 158. Remaining lifetimes of bearings, seals, housing, and shafts may be used in predicting remaining useful lifetime of the gearbox. As a further example, bearing 158 in FIG. 1C may have an expected lifetime of 2000 hours for estimated future operating conditions while all other components in gearbox 104 have expected lifetimes longer than 2000 hours. In this case, the life of the gearbox 104 is determined as 2000 hours.

In the depicted embodiment, predicting lives of components is performed on a component-by-component basis. First, a component i is selected 356. Remaining life of the component may be looked up 358 from the past evaluation cycle and used as the starting point of prediction. A matching component between component i and components in the training data is identified 207 using a knowledge base. The knowledge base includes component data or data related to component i. For example, the knowledge base includes manufacturing process parameters and factors of component i, and gearbox design parameters of component i such as dimensions, angles, and ratios with other components. The knowledge base may also include supplier data of component i such as supplier's historical life factors. The knowledge base may include installation data of component i such as installation features, mounting, and orientation, and may include environmental data such as ambient temperature, pressure, humidity, and altitude. The knowledge base may include training data, such as lives and failure modes of failed components. The knowledge base may also include life correlation factors of component i or failure mode j with other components and/or other failure modes. The identified matching component may have the same or similar parameters in one or more of parameters or factors in the knowledge base.

In the exemplary embodiment, based on the identified matching component, a strategy is selected 360 from a rule base. The rule base includes rules in identifying failure and causes. The rule is part of the model, where specific life prediction calculation approach is selected. For example, the rules may include using certain parameters while ignoring or giving lower weight to certain other parameters in predicting 206 the life of component i or failure mode j. In another example, the rule may be matching a similarly-loaded test dataset to the gearbox being measured. Alternatively, the rule may be grouping the gearboxes based on the environment conditions and loads. The rules may include multiple grouping ways of the gearbox that is being measured and failed gearboxes in the testing database. The goal of the rule selection is to match components of a gearbox that has already failed and has a known life to components of the working gearbox that is being measured.

Once a strategy is selected, the life Lᵢ for component i and Lⱼ for failure mode j is predicted based on the strategy. Predicting 206 life of component i and failure mode j is repeated.

In the depicted embodiment, after predicting 206 lives of components and failure modes is completed, a remaining life of the gearbox is predicted 204. During the evaluation, if a failure has already occurred, manual inspection may be conducted 362 on the gearbox to determine the failed component(s) and associated failure modes. The inspection results may be used 364 to adjust life prediction model 122 (FIG. 1A). For example, life prediction model 122 may be rewarded or adjusted based on the prediction accuracy.

In operation, measured data are compared side-by-side with data from training examples. Cumulative running time and life of a comparable gearbox from a training dataset are used to generate an expected remaining life of the gearbox. The predicted life reduction during the measured interval is calculated, based on the training data. Method 200-a does not use a physics-based model, which may be too conservative or too liberal. For example, if bearings are pressed at higher load during the manufacture, the lives of the bearings may be reduced. Imperceptible supplier created component defects associated with a specific batch of supplies within a timeframe may impact the life of a gearbox. Differences in components in gearbox 104 may not be captured through inspection and/or quality control steps, and may lead to deviation in life calculation if only a physics model based on empirical equations or empirical relations is used. Empirical equations may be obtained experimentally by performing tests. Empirical relations may also be provided in industrial standards such as ISO 6336 for helical gears and ISO 281 for bearing lifetime calculations. The model is updated over time as more data are fed into the model. Field data driven ML based method captures the above-described failure mechanisms and information specific to a gearbox and/or components, improving prediction accuracy.

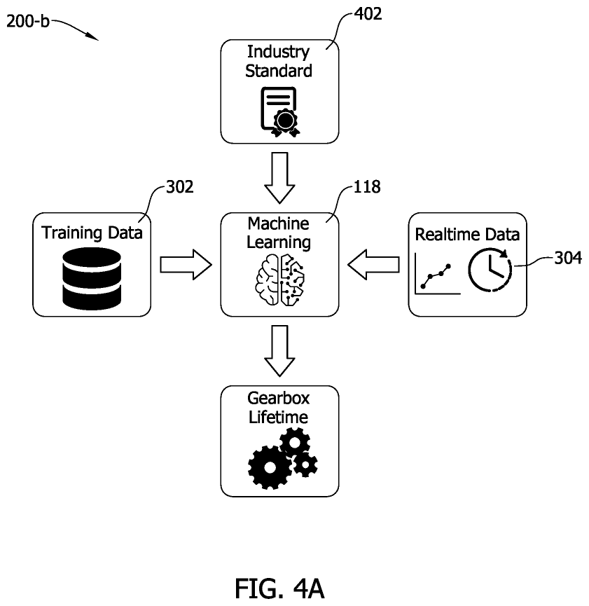

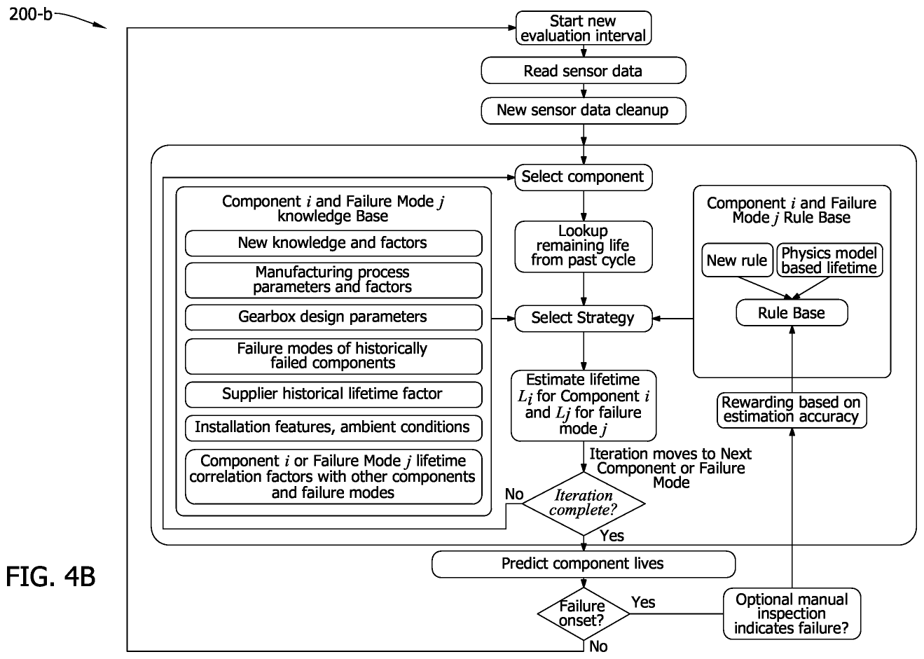

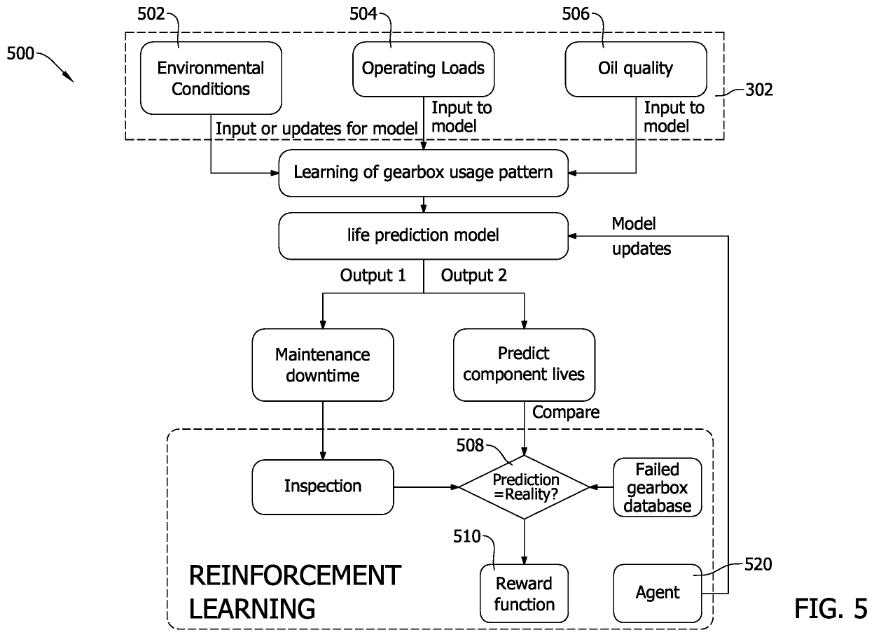

FIGS. 4A and 4B show another embodiment 200-b of predicting life of a gearbox. FIG. 4A is a schematic diagram of method 200-b. FIG. 3B is a flow chart of method 200-b.

While method 200-a is able to predict gearbox life, a large training database may be needed, which may take a long time to develop, to provide sufficient confidence that the predicted life is accurate for a gearbox operating in previously untested environment or condition, or when a gearbox with different manufacturing parameters is used. To mitigate the lack of data in the initial period of method 200-a, method 200-b is used.

Method 200-b is a modified ML algorithm, where method 200-b is used to calculate expected gearbox life based on a combination of a physics model and machine learning from training dataset. In the exemplary embodiment, compared to method 200-a shown in FIG. 3A, in method 200-b, besides real time data 302 and training data 304, empirical relations 402 such as industry standards are input into machine learning model 118 in predicting 204 life of a gearbox. Empirical relations 402 are used in a physics model for predicting remaining useful lifetime of a component of a gearbox. In a rule base for method 200-b, a rule of predicting remaining useful lifetime based on a physics model is included in the rule base.

In the exemplary embodiment, the calculation is initially based on established gearbox equations following empirical relations, material properties, and dimensions. With more training examples of a particular gearbox, component materials and manufacturing procedures, the calculation becomes more heavily based on the machine learning evaluations. A rule requiring the use of a physics model may be deactivated when a predetermine condition is met, such as a certain number of training examples being available. Transitioning to a machine learning model improves prediction accuracy, especially when the empirical relations do not provide an accurate expected gearbox life prediction.

In the exemplary embodiment, the gearbox operating parameters (e.g. torque, overhung shaft forces, and oil quality) are provided by sensors. They are fed into a central computing unit, which may be an EDGE unit or a cloud computing system. The computing unit is programmed with equations that relate torque and OHL to the wear of a gearbox, and the wear of the gearbox is then accumulated together, as mentioned in ISO6336 Part 6 (Miner's rule). Similarly, if the machine learning method is used, then the current load is weighted into the mode and the remaining life is computed with equations developed by the model, using the training example. The oil quality may be added to the machine learning algorithm as additional data. If the gearbox oil quality is not maintained, the model decreases the life predict, but if the oil quality meets specifications, then the life predict is not adversely affected.

Referring back to FIG. 1A, machine learning model 118 may also be used to predict future usage of gearbox 104. Remaining useful lifetime prediction for a gearbox is based on assumed future loads. In methods 200-a, 200-b, the current loading condition is assumed to continue indefinitely. Therefore, as soon as load condition changes, the new predicted life will need to be provided to fit to the new loading condition. This solution may not be ideal in situations where load patterns are not constant, e.g. equipment used for short periods (single shift per day, single season in a year). In predicting future usage, a gearbox loading history chart (histogram over time) is created and used to predict the future loads with an increased accuracy. Future loads of increased accuracy may be used in methods 200-a and 200-b to increase the accuracy in predicting life of gearboxes, where the prediction is based on the predicted future loads instead of assumed future loads.

In predicting future loads, the gearbox loads are being recorded, and the historic data are used to predict future gearbox loads. In one embodiment, the measured gearbox usage data are extrapolated into the future. Extrapolation may be done in several ways. One way is to learn the usage with machine learning algorithms. The algorithm may utilize histograms on which prior and current torques, speeds, and overhung shaft forces (if any) are logged. The more data is fed into the histograms, the more confident predictions about usage of the gearbox for the rest of the life may be made.

Consider the following example:

A gearbox “GB1” is used in an aggregate production facility. The loads that are being recorded show very high torque ripples when rocks are being crushed. The loads are present only during regular business hours, and the gearbox is not used at night.

A second gearbox “GB2” is used in a wastewater treatment plant to drive a clarifier. This gearbox sees almost constant torques with minimum ripples and no downtime, i.e., it runs day and night.

Although the hours of operation of GB1 are only about ⅓ of that of GB2, the severe service that gearbox is subjected to may cause a physics model or a ML model to predict much shorter remaining lives for GB1 than for GB2, if loads are not considered. Therefore, prediction of future loads increase accuracy in predicting remaining useful lifetime.

Histograms described above do not retain information about the order in which loads are applied which may affect a damage accumulation model. Therefore, the ML of gearbox usage may also employ strip charts or spectrograms (in frequency domain) that keep track of the order in time.

Predicted future loads may be used in estimating the remaining useful lifetime of a gearbox. For example, predicted future loads are input into life prediction model 122 with other data such as sensor data into life prediction model 122.

FIG. 5 is a flow chart of an exemplary process 500 of reinforcement learning. Machine learning model 118 is a reinforcement machine learning model, and may further include an agent 520. An agent is an entity in a machine learning model that applies a change to the parameters of the machine learning model using a reward function based on a comparison between predictions by the model and ground truth/actual data. For example, if the reward function is positive, agent 520 does not make a change to model 122. If the reward function is negative or otherwise relatively small, which indicates that the predictions by model 122 are unsatisfactory, agent 520 updates or adjusts model 122. In the depicted embodiment, agent is used to adjust life prediction model 122 using the feedback from inspection data (also see FIGS. 3B and 4B).

In the exemplary embodiment, real time data 302 such as environmental conditions 502, operating loads 504, and/or oil quality 506 are input into machine learning model 118. Machine learning model 118 may be used to learn and/or predict gearbox usage patterns. Life prediction model 122 of machine learning model 118 may be used to predict lives of components. Outputs of life prediction model 122 may be sent to a field engineer or a customer to be used as a maintenance schedule. During maintenance downtime, gearbox 104 is inspected and determine the lives and failures of components of gearbox. The data acquired during inspection and data in failed gearbox database are the ground truth of the lives of the components, and are compared 508 with predicted lives of the components. The comparison is input into a reward function. Agent 520 applies changes to life prediction model 122. For example, if the prediction accuracy is within the predetermined level such as less than 20% different from ground truth, the reward function outputs a positive value and agent 520 does not change life prediction model 122. On the other hand, if the prediction accuracy is not within a predetermine level, the reward function 510 outputs a negative value and agent 520 updates life prediction model 122 such as changing weights to factors in the calculation of life. As a result, life prediction model 122 is updated as computing device 110 is used to predict life of gearbox 104. Therefore, machine learning model 118 does not have to be pretrained before computing device 110 is used for life prediction, which is advantageous because training data, especially a large training dataset, are not always available and training may take some time.

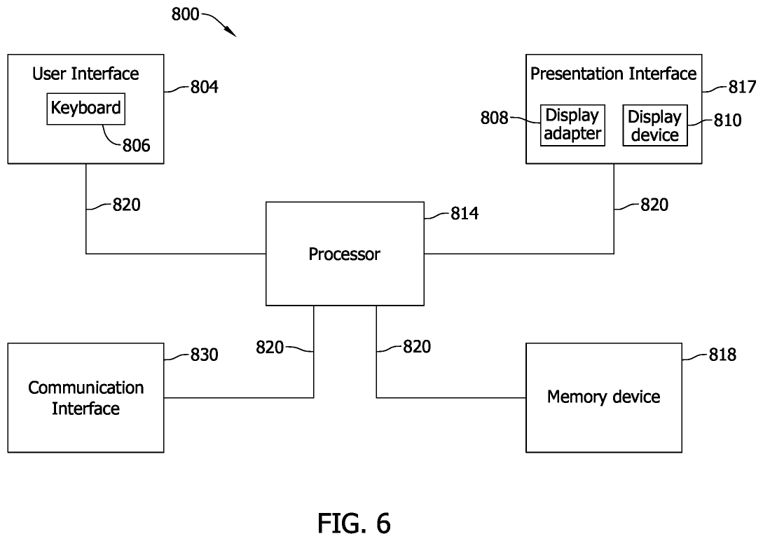

The life prediction computing device 110 described herein may be any suitable user computing device 800 and software implemented therein. FIG. 6 is a block diagram of an exemplary computing device 800. In the exemplary embodiment, the computing device 800 includes a user interface 804 that receives at least one input from a user. The user interface 804 may include a keyboard 806 that enables the user to input pertinent information. The user interface 804 may also include, for example, a pointing device, a mouse, a stylus, a touch sensitive panel (e.g., a touch pad and a touch screen), a gyroscope, an accelerometer, a position detector, and/or an audio input interface (e.g., including a microphone).

Moreover, in the exemplary embodiment, computing device 800 includes a presentation interface 817 that presents information, such as input events and/or validation results, to the user. The presentation interface 817 may also include a display adapter 808 that is coupled to at least one display device 810. More specifically, in the exemplary embodiment, the display device 810 may be a visual display device, such as a cathode ray tube (CRT), a liquid crystal display (LCD), a light-emitting diode (LED) display, and/or an “electronic ink” display. Alternatively, the presentation interface 817 may include an audio output device (e.g., an audio adapter and/or a speaker) and/or a printer.

The computing device 800 also includes a processor 814 and a memory device 818. The processor 814 is coupled to the user interface 804, the presentation interface 817, and the memory device 818 via a system bus 820. In the exemplary embodiment, the processor 814 communicates with the user, such as by prompting the user via the presentation interface 817 and/or by receiving user inputs via the user interface 804. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are exemplary only, and thus are not intended to limit in any way the definition and/or meaning of the term “processor.”

In the exemplary embodiment, the memory device 818 includes one or more devices that enable information, such as executable instructions and/or other data, to be stored and retrieved. Moreover, the memory device 818 includes one or more computer readable media, such as, without limitation, dynamic random access memory (DRAM), static random access memory (SRAM), a solid state disk, and/or a hard disk. In the exemplary embodiment, the memory device 818 stores, without limitation, application source code, application object code, configuration data, additional input events, application states, assertion statements, validation results, and/or any other type of data. The computing device 800, in the exemplary embodiment, may also include a communication interface 830 that is coupled to the processor 814 via the system bus 820. Moreover, the communication interface 830 is communicatively coupled to data acquisition devices.

In the exemplary embodiment, the processor 814 may be programmed by encoding an operation using one or more executable instructions and providing the executable instructions in the memory device 818. In the exemplary embodiment, the processor 814 is programmed to select a plurality of measurements that are received from data acquisition devices.

In operation, a computer executes computer-executable instructions embodied in one or more computer-executable components stored on one or more computer-readable media to implement aspects of the disclosure described and/or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

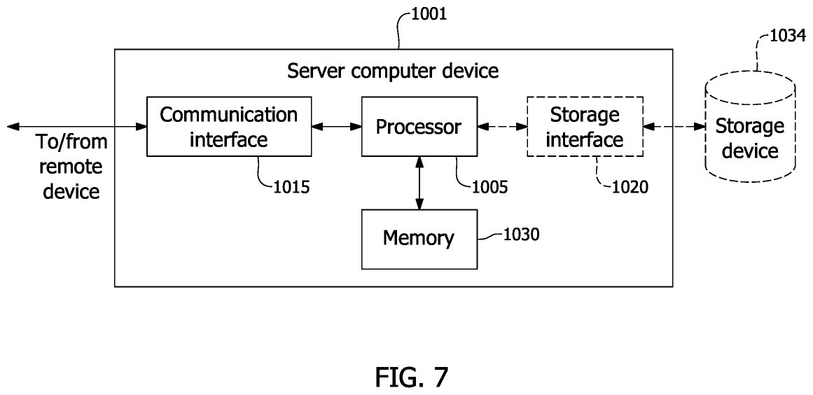

FIG. 7 illustrates an exemplary configuration of a server computer device 1001 such as life prediction computing device 114. The server computer device 1001 also includes a processor 1005 for executing instructions. Instructions may be stored in a memory area 1030, for example. The processor 1005 may include one or more processing units (e.g., in a multi-core configuration).

The processor 1005 is operatively coupled to a communication interface 1015 such that server computer device 1001 is capable of communicating with a remote device such as gearbox assembly 102, sensor 106, or another server computer device 1001. For example, communication interface 1015 may receive data from life prediction computing device 110 and sensor 106, via the Internet.

The processor 1005 may also be operatively coupled to a storage device 1034. The storage device 1034 is any computer-operated hardware suitable for storing and/or retrieving data, such as, but not limited to, wavelength changes, temperatures, and strain. In some embodiments, the storage device 1034 is integrated in the server computer device 1001. For example, the server computer device 1001 may include one or more hard disk drives as the storage device 1034. In other embodiments, the storage device 1034 is external to the server computer device 1001 and may be accessed by a plurality of server computer devices 1001. For example, the storage device 1034 may include multiple storage units such as hard disks and/or solid state disks in a redundant array of inexpensive disks (RAID) configuration. The storage device 1034 may include a storage area network (SAN) and/or a network attached storage (NAS) system.

In some embodiments, the processor 1005 is operatively coupled to the storage device 1034 via a storage interface 1020. The storage interface 1020 is any component capable of providing the processor 1005 with access to the storage device 1034. The storage interface 1020 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 1005 with access to the storage device 1034.

The computer-implemented methods discussed herein may include additional, less, or alternate actions, including those discussed elsewhere herein. The methods may be implemented via one or more local or remote processors, transceivers, servers, and/or sensors, and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

In some embodiments, the design system is configured to implement machine learning, such that the neural network “learns” to analyze, organize, and/or process data without being explicitly programmed. Machine learning may be implemented through machine learning (ML) methods and algorithms. In an exemplary embodiment, a machine learning (ML) module is configured to implement ML methods and algorithms. In some embodiments, ML methods and algorithms are applied to data inputs and generate machine learning (ML) outputs. Data inputs may include but are not limited to analog and digital signals (e.g. sound, light, motion, or natural phenomena). Data inputs may further include: sensor data, image data, video data, and telematics data. ML outputs may include but are not limited to: numeric data, digital signals (e.g. information data converted from natural phenomena). ML output is primarily a remaining useful life of a gearbox, or its specific component. ML outputs may further include: image or video recognition, statistical models, robotics behavior modeling, signal detection, fraud detection analysis, user input recommendations and personalization, game AI, skill acquisition, targeted marketing, big data visualization, and/or information extracted about a computer device, a user, a home, a vehicle, or a party of a transaction. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, recurrent neural networks, Monte Carlo search trees, generative adversarial networks, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function which maps outputs to inputs and utilize the predictive function to generate ML outputs based on data inputs. The example inputs and example outputs of the training data may include any of the data inputs or ML outputs described above. For example, a ML module may receive training data including data associated with different signals received and their corresponding classifications, generate a model which maps the signal data to the classification data, and recognize future signals and determine their corresponding categories.

In another embodiment, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship. In an exemplary embodiment, a ML module coupled to or in communication with the design system or integrated as a component of the design system receives unlabeled data including event data, financial data, social data, geographic data, cultural data, signal data, and political data, and the ML module employs an unsupervised learning method such as “clustering” to identify patterns and organize the unlabeled data into meaningful groups. The newly organized data may be used, for example, to extract further information about the potential classifications.

In yet another embodiment, ML methods and algorithms are directed toward reinforcement learning, which involves optimizing outputs based on feedback from a reward signal. Specifically ML methods and algorithms directed toward reinforcement learning may receive a user-defined reward signal definition, receive a data input, utilize a decision-making model to generate a ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In an exemplary embodiment, a ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict optimal constraints.

As used herein, the terms “processor” and “computer,” and related terms, e.g., “processing device,” “computing device,” and “controller” are not limited to just those integrated circuits referred to in the art as a computer, but broadly refers to a microcontroller, a microcomputer, an analog computer, a programmable logic controller (PLC), an application specific integrated circuit (ASIC), and other programmable circuits, and these terms are used interchangeably herein. In the embodiments described herein, “memory” may include, but is not limited to, a computer-readable medium, such as a random-access memory (RAM), a computer-readable non-volatile medium, such as a flash memory. Alternatively, a floppy disk, a compact disc-read only memory (CD-ROM), a magneto-optical disk (MOD), and/or a digital versatile disc (DVD) may also be used. Also, in the embodiments described herein, additional input channels may be, but are not limited to, computer peripherals associated with an operator interface such as a touchscreen, a mouse, and a keyboard. Alternatively, other computer peripherals may also be used that may include, for example, but not be limited to, a scanner. Furthermore, in the example embodiment, additional output channels may include, but not be limited to, an operator interface monitor or heads-up display. Some embodiments involve the use of one or more electronic or computing devices. Such devices typically include a processor, processing device, or controller, such as a general purpose central processing unit (CPU), a graphics processing unit (GPU), a microcontroller, a reduced instruction set computer (RISC) processor, an ASIC, a programmable logic controller (PLC), a field programmable gate array (FPGA), a digital signal processing (DSP) device, and/or any other circuit or processing device capable of executing the functions described herein. The methods described herein may be encoded as executable instructions embodied in a computer readable medium, including, without limitation, a storage device and/or a memory device. Such instructions, when executed by a processing device, cause the processing device to perform at least a portion of the methods described herein. The above examples are not intended to limit in any way the definition and/or meaning of the term processor and processing device.

At least one technical effect of the systems and methods described herein includes (a) predicting remaining useful lifetime of a gearbox using a machine learning model, which has an increased accuracy than using a physics model only; (b) updating the machine learning model while using the machine learning model to predict remaining useful lifetime of a gearbox, thereby using a machine learning model that is not pretrained; (c) reducing demand on training data by using a combination of a physical model and a machine learning model; and (d) predicting future loads of a gearbox, thereby increasing prediction accuracy of the machine learning model.

Exemplary embodiments of systems and methods of predicting remaining useful lifetime of a gearbox are described above in detail. The systems and methods are not limited to the specific embodiments described herein but, rather, components of the systems and/or operations of the methods may be utilized independently and separately from other components and/or operations described herein. Further, the described components and/or operations may also be defined in, or used in combination with, other systems, methods, and/or devices, and are not limited to practice with only the systems described herein.

Although specific features of various embodiments of the invention may be shown in some drawings and not in others, this is for convenience only. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A life prediction system for industrial mechanical power transmission equipment, the system comprising:
a life prediction computing device, the life prediction computing device comprising at least one processor in communication with at least one memory device, and the at least one processor programmed to:
receive data of a gearbox measured by one or more sensors;
predict remaining useful lifetime of the gearbox based on the received data by using a machine learning model, wherein the machine learning model incudes a life prediction model, and the at least one processor is further programmed to:
in the life prediction model, for each component of the gearbox and each failure mode,
identify a matching component of the component with an existing component in a database, wherein the database includes data of failed gearboxes and failure modes of the failed gearboxes;
select a strategy in a rule base of predicting remaining useful lifetime of the component; and
predict a life of the component at the failure mode using the strategy based on the matching component; and
predict a life of the gearbox based on the predicted lives of the components; and
output the predicted life of the gearbox.

2. The system of claim 1, wherein the machine learning model includes an agent, and the at least one processor is further configured to:
compare ground truth of lives of the components with the predicted lives of the components;
update a reward function based on the comparison; and
modify the life prediction model by the agent using the reward function.

3. The system of claim 1, wherein the at least one processor is further programmed to determine the matching component based on at least one of component data, installation data, or environmental data.

4. The system of claim 1, wherein the at least one processor is further programmed to determine the matching component based on supplier data of the component.

5. The system of claim 1, wherein the at least one processor is further programmed to determine the matching component based on correlations of the component and the failure mode with other components and other failure modes.

6. The system of claim 1, wherein the at least one processor is further programmed to:
derive frequency spectra of the data; and
predict the life of the gearbox based on the frequency spectra of the data.

7. The system of claim 1, wherein the at least one processor is further programmed to:
select the strategy in the rule base that includes a rule of predicting the life using a physics model.

8. The system of claim 7, wherein the at least one processor is further programmed to:
predict the life of the component using the physics model.

9. The system of claim 7, wherein the at least one processor is further programmed to:
deactivate the rule of predicting the life using the physics model in the rule base when a predetermined condition is met; and
predict the life of the component based on training data.

10. The system of claim 1, wherein the at least one processor is further programmed to:
predict future loads of the gearbox using the machine learning model or extrapolation of past historical load; and
feeding the predicted future loads to the machine learning model to estimate remaining useful life.

11. A method of predicting remaining useful lifetime of industrial mechanical power transmission equipment, comprising:
receiving data of the power transmission equipment measured by one or more sensors;
predicting remaining useful lifetime of the power transmission equipment based on the received data by using a machine learning model, wherein the machine learning model incudes a life prediction model, and wherein predicting remaining useful lifetime of the power transmission equipment further comprising:
in the life prediction model, for each component of the power transmission equipment and each failure mode,
identifying a matching component of the component with an existing component in a database, wherein the database includes data of failed power transmission equipment and failure modes of the failed power transmission equipment;
selecting a strategy in a rule base of predicting remaining useful lifetime of the component; and
predicting a life of the component at the failure mode using the strategy based on the matching component; and
predicting a life of the power transmission equipment based on the predicted lives of the components; and
outputting the predicted life of the power transmission equipment.

12. The method of claim 11, wherein the machine learning model includes an agent, and the method further comprising:
comparing ground truth of lives of the components with the predicted lives of the components;
updating a reward function based on the comparison; and
modifying the life prediction model by the agent using the reward function.

13. The method of claim 11, wherein identifying a matching component further comprises determining the matching component based on at least one of component data, installation data, environmental data, or supplier data of the component.

14. The method of claim 11, wherein identifying a matching component further comprises determining the matching component based on correlations of the component and the failure mode with other components and other failure modes.

15. The method of claim 11, wherein:
receiving data further comprises deriving frequency spectra of the data; and
predicting remaining useful lifetime of the power transmission equipment further comprises predicting the remaining useful lifetime of the power transmission equipment based on the frequency spectra of the data.

16. The method of claim 11, wherein selecting a strategy further comprises:
selecting the strategy in the rule base that includes a rule of predicting the life using a physics model.

17. The method of claim 16, wherein predicting the life of the component further comprises:
predicting the life of the component using the physics model.

18. The method of claim 16, wherein predicting the life of the component further comprises:
deactivating the rule of predicting the life using the physics model in the rule base when a predetermined condition is met; and
predicting the life of the component based on training data.

19. The method of claim 11, wherein predicting remaining useful lifetime of the power transmission equipment further comprises:
predicting future loads of the power transmission equipment using the machine learning model or extrapolation of past historical load; and
feeding the predicted future loads to the machine learning model to estimate the remaining useful life of the power transmission equipment.

20. A life prediction system for a gearbox, the system comprising:
a life prediction computing device, the life prediction computing device comprising at least one processor in communication with at least one memory device, and the at least one processor programmed to:
receive data of the gearbox measured by one or more sensors;
predict remaining useful lifetime of the gearbox based on the received data by using a machine learning model; and
output the predicted life of the gearbox.
